(19) United States
(12) Patent Application Publication
(10) Pub. No.: US 2020/0065555 A1
(43) Pub. Date: Feb. 27, 2020

(54) METHOD FOR OPTICAL FINGERPRINT RECOGNITION AND RELATED PRODUCTS

(71) Applicant: GUANGDONG OPPO MOBILE TELECOMMUNICATIONS CORP., LTD., Dongguan (CN)

(72) Inventor: Yibao ZHOU, Dongguan (CN)

(21) Appl. No.: 16/667,342

(22) Filed: Oct. 29, 2019

Related U.S. Application Data
(63) Continuation of application No. PCT/CN2018/082210, filed on Apr. 8, 2018.

(30) Foreign Application Priority Data
May 3, 2017 (CN) 201710305567.3

(51) Int. Cl. G06K 9/00; G06T 5/00

(52) U.S. Cl. CPC G06K 9/00087; G06K 9/0004; G06T 5/002

(57) ABSTRACT

A method for optical fingerprint recognition and related products are provided. The method includes the following. When a touch display screen detects a touch operation of a user in a first area, an optical fingerprint recognition module of a terminal collects fingerprint data of the user, and sends the fingerprint data to an application processor (AP). The AP of the terminal obtains denoised fingerprint data by denoising the fingerprint data according to pre-collected noise data. The AP of the terminal compares the denoised fingerprint data with pre-stored fingerprint template data, and determines that fingerprint verification passes upon determining that the denoised fingerprint data is matched with the pre-stored fingerprint template data.

### CROSS-REFERENCE TO RELATED APPLICATIONS

This application is a continuation of International Application No. PCT/CN2018/082210, filed on Apr. 8, 2018, which claims priority to Chinese Patent Application No. 201710305567.3, filed on May 3, 2017, the entire disclosures of which are incorporated herein by reference.

### TECHNICAL FIELD

This disclosure relates to the field of data transmission technologies, and more particularly to a method for optical fingerprint recognition and related products.

### BACKGROUND

With the popularity of terminals such as smart phones, in modern life, almost everybody has a mobile phone. Currently, mobile phones generally adopt a fingerprint recognition technology, and fingerprint recognition can be used in various scenarios such as terminal unlocking, mobile payment, and the like.

The optical fingerprint recognition technology is widely applied to a fingerprint recognition module of various terminals because of its good stability and high recognition sensitivity. An optical fingerprint recognition module generally includes a light source and an optical fingerprint detection module. An imaging principle of optical fingerprint recognition is as follows: the light source emits lights; the lights pass through a surface of a display screen on which a finger is pressed and then are reflected to the optical fingerprint recognition module; the optical fingerprint recognition module receives and processes the lights reflected to obtain a fingerprint image. A principle of fingerprint comparison is as follows: the optical fingerprint recognition module compares the fingerprint image obtained with a pre-stored fingerprint image to obtain a comparison result.

However, since a user's finger may easily leave a fingerprint mark when pressing the surface of the display screen, and the residual fingerprint mark often affects a recognition result of the optical fingerprint recognition module, which results in deviation between a collected fingerprint image and a real fingerprint image, thereby reducing fingerprint matching success rate of the optical fingerprint recognition module.

### SUMMARY

In a first aspect of the present disclosure, a method for optical fingerprint recognition is provided. The method is applicable to a terminal including an application processor (AP), a touch display screen, and an optical fingerprint recognition module having a fingerprint recognition area located in a first area of the touch display screen. The method includes the following. The optical fingerprint recognition module collects fingerprint data of a user when the touch display screen detects a touch operation of the user in the first area, and sends the fingerprint data to the AP. The AP obtains denoised fingerprint data by denoising the fingerprint data according to pre-collected noise data. The AP compares the denoised fingerprint data with pre-stored fingerprint template data, and determines that fingerprint verification passes upon determining that the denoised fingerprint data is matched with the pre-stored fingerprint template data.

In a second aspect of the present disclosure, a terminal is provided. The terminal includes an AP, a touch display screen, and an optical fingerprint recognition module having a fingerprint recognition area located in a first area of the touch display screen. The optical fingerprint recognition module is configured to collect fingerprint data of a user when the touch display screen detects a touch operation of the user in the first area and send the fingerprint data to the AP. The AP is configured to obtain denoised fingerprint data by denoising the fingerprint data according to pre-collected noise data. The AP is further configured to compare the denoised fingerprint data with pre-stored fingerprint template data. The AP is further configured to determine that fingerprint verification passes when the denoised fingerprint data is matched with the pre-stored fingerprint template data.

In a third aspect of the present disclosure, a non-transitory computer readable storage medium is provided. The non-transitory computer readable storage medium is configured to store computer programs which, when executed by a processor of a terminal, cause the processor to carry out part or all of the operations described in any method of the first aspect of the embodiments of the present disclosure.

### BRIEF DESCRIPTION OF THE DRAWINGS

In order to describe technical solutions of embodiments of the present disclosure or the related art more clearly, the following will give a brief description of accompanying drawings used for describing the embodiments of the present disclosure or the related art. Apparently, accompanying drawings described below are merely some embodiments of the present disclosure. Those of ordinary skill in the art can also obtain other accompanying drawings based on the accompanying drawings described below without creative efforts.

FIG. 1A is a schematic diagram illustrating a working principle of an optical fingerprint recognition module according to an embodiment of the present disclosure.

FIG. 1B is a schematic structural diagram illustrating a terminal according to an embodiment of the present disclosure.

FIG. 1C is a schematic structural diagram illustrating a fingerprint recognition area according to an embodiment of the present disclosure.

FIG. 2 is a schematic flowchart illustrating a method for optical fingerprint recognition according to an embodiment of the present disclosure.

FIG. 3 is a schematic flowchart illustrating a method for optical fingerprint recognition according to another embodiment of the present disclosure.

FIG. 4 is a schematic flowchart illustrating a method for optical fingerprint recognition according to another embodiment of the present disclosure.

FIG. 5 is a schematic structural diagram illustrating a terminal according to another embodiment of the present disclosure.

FIG. 6 is a schematic structural diagram illustrating a device for optical fingerprint recognition according to an embodiment of the present disclosure.

FIG. 7 is a schematic structural diagram illustrating a device for optical fingerprint recognition according to another embodiment of the present disclosure.

FIG. 8 is a schematic structural diagram illustrating a terminal according to still another embodiment of the present disclosure.

### DETAILED DESCRIPTION

In order for those skilled in the art to better understand technical solutions of the present disclosure, technical solutions of embodiments of the present disclosure will be described clearly and completely with reference to accompanying drawings in the embodiments of the present disclosure. Apparently, embodiments described hereinafter are merely some embodiments, rather than all embodiments, of the present disclosure. All other embodiments obtained by those of ordinary skill in the art based on the embodiments of the present disclosure without creative efforts shall fall within the protection scope of the present disclosure.

The terms “first”, “second”, and the like used in the specification, the claims, and the accompany drawings of the present disclosure are used to distinguish different objects rather than describe a particular order. The terms “include”, “comprise”, and “have” as well as variations thereof are intended to cover non-exclusive inclusion. For example, a process, method, system, product, or device including a series of steps or units is not limited to the listed steps or units, on the contrary, it can optionally include other steps or units that are not listed; alternatively, other steps or units inherent to the process, method, product, or device can be included either.

The term “embodiment” referred to herein means that particular features, structures, or properties described in conjunction with the embodiments may be contained in at least one embodiment of the present disclosure. The phrase appearing in various places in the specification does not necessarily refer to the same embodiment, nor does it refer to an independent or alternative embodiment that is mutually exclusive with other embodiments. It is expressly and implicitly understood by those skilled in the art that an embodiment described herein may be combined with other embodiments.

The terminal involved in the embodiments of the present disclosure may include various handheld devices, on-board devices, wearable devices, computing devices that have wireless communication functions, or other processing devices connected to a wireless modem, as well as various forms of user equipment (UE), mobile stations (MS), terminal devices, and the like. For convenience of description, the above-mentioned devices are collectively referred to as terminals.

Hereinafter, embodiments of the present disclosure will be described in detail.

According to an embodiment of the disclosure, a method for optical fingerprint recognition is provided. The method is applicable to a terminal including an application processor (AP), a touch display screen, and an optical fingerprint recognition module having a fingerprint recognition area located in a first area of the touch display screen. The method includes the following. The optical fingerprint recognition module collects fingerprint data of a user when the touch display screen detects a touch operation of the user in the first area, and sends the fingerprint data to the AP. The AP obtains denoised fingerprint data by denoising the fingerprint data according to pre-collected noise data. The AP compares the denoised fingerprint data with pre-stored fingerprint template data, and determines that fingerprint verification passes upon determining that the denoised fingerprint data is matched with the pre-stored fingerprint template data.

According to an embodiment of the disclosure, a terminal is provided. The terminal includes an AP, a touch display screen, and an optical fingerprint recognition module having a fingerprint recognition area located in a first area of the touch display screen. The optical fingerprint recognition module is configured to collect fingerprint data of a user when the touch display screen detects a touch operation of the user in the first area and send the fingerprint data to the AP. The AP is configured to obtain denoised fingerprint data by denoising the fingerprint data according to pre-collected noise data. The AP is further configured to compare the denoised fingerprint data with pre-stored fingerprint template data. The AP is further configured to determine that fingerprint verification passes when the denoised fingerprint data is matched with the pre-stored fingerprint template data.

According to an embodiment of the disclosure, a non-transitory computer readable storage medium is provided. The non-transitory computer readable storage medium is configured to store computer programs which, when executed by a processor of a terminal, cause the processor to carry out following actions. Fingerprint data of a user is collected when a touch operation of the user is detected and the fingerprint data is sent to an AP of the terminal. Denoised fingerprint data is obtained by denoising the fingerprint data according to pre-collected noise data. The denoised fingerprint data is compared with pre-stored fingerprint template data. Upon determining that the denoised fingerprint data is matched with the pre-stored fingerprint template data, determine that fingerprint verification passes.

Embodiments of the present disclosure will be detailed below with reference to the accompanying drawings.

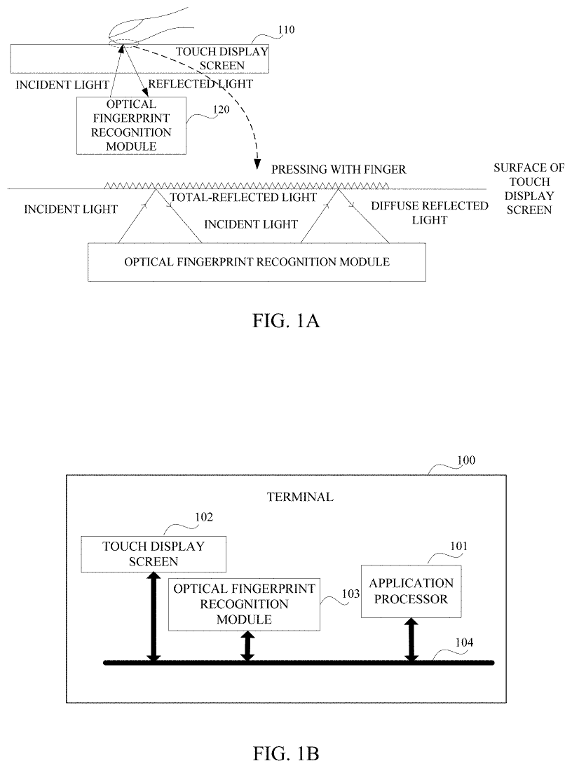

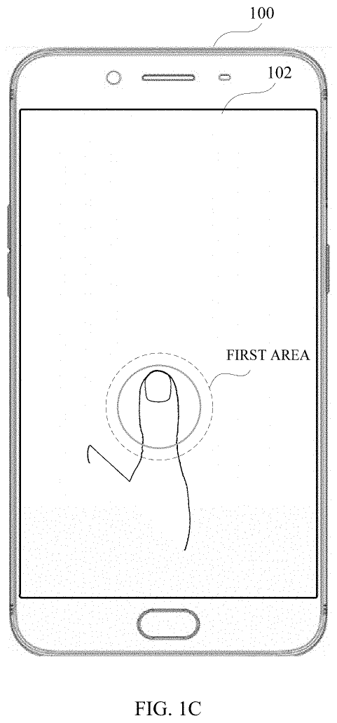

For a better understanding of embodiments of the present disclosure, a working principle of an optical fingerprint recognition module of the embodiments of the present disclosure is introduced first. FIG. 1A is a schematic diagram illustrating a working principle of an optical fingerprint recognition module according to an embodiment of the present disclosure. As illustrated in FIG. 1A, a touch display screen 110 and an optical fingerprint recognition module 120 are illustrated. The optical fingerprint recognition module 120 can emit lights, which can be referred to as incident lights. The incident lights pass through an area of the touch display screen that is in contact with a finger, and then are reflected by patterns of the finger. Reflected lights are received by the optical fingerprint recognition module 120. According to the total reflection (also known as total internal reflection) principle, the optical fingerprint recognition module 120 can determine which incident lights are projected onto convex portions of a fingerprint (i.e., ridges of the fingerprint) and which incident lights are projected onto concave portions of the fingerprint (i.e., valleys of the fingerprint).

Referring to an enlarged dotted line area of FIG. 1A, in a surface of the touch display screen, the ridges of the fingerprint are in contact with the surface of the touch display screen, while the valleys of the fingerprint are not. On one hand, when incident lights generated by the optical fingerprint recognition module 120 are projected onto the valleys of the fingerprint, the incident lights are projected onto a surface of the touch display screen that is in contact with air. In this case, total reflection of the incident lights can be achieved by designing incident angles of the incident lights (a refractive index of the air is approximately equal to 1 and a refractive index of material of the touch display screen is greater than 1, accordingly, the refractive index of the material of the touch display screen is set to be greater than that of the air). In this way, the optical fingerprint recognition module 120 can receive strong total-reflected lights. On the other hand, when the incident lights generated by the optical fingerprint recognition module 120 are projected onto the ridges of the fingerprint, the incident lights are projected onto a surface of the touch display screen that is in contact with the convex portions of the fingerprint. In this situation, since the incident lights are projected onto the convex portions of the fingerprint, diffuse reflection occurs. As such, the optical fingerprint recognition module 120 can receive weak diffuse reflected lights. Therefore, the optical fingerprint recognition module 120 can obtain a fingerprint image according to received lights of different intensities.

FIG. 1B is a schematic structural diagram illustrating a terminal according to an embodiment of the present disclosure. As illustrated in FIG. 1B, a terminal 100 includes an AP 101, a touch display screen 102, and an optical fingerprint recognition module 103. The optical fingerprint recognition module 103 has a fingerprint recognition area located in a first area of the touch display screen 102. The AP 101 is coupled with the touch display screen 102 and the optical fingerprint recognition module 103 via a bus 104.

The optical fingerprint recognition module 103 is configured to collect fingerprint data of a user when the touch display screen 102 detects a touch operation of the user in the first area and send the fingerprint data to the AP 101.

The first area may be any preset area of the touch display screen 102. The preset area may be located at any position of the touch display screen 102, such as, on the upper left side (as illustrated in FIG. 1C), the upper side, the lower side, the left side, and the right side of the touch display screen 102. The size of the preset area is able to be covered by the fingerprint area of the finger. The preset area may be any shape, such as, a circular shape, an elliptical shape, a quadrangular shape (e.g., a rectangular shape), a fingerprint-like shape, and so on, which is not limited herein.

The touch display screen 102 of embodiments of the present disclosure may be a thin film transistor-liquid crystal display (TFT-LCD), a light emitting diode (LED) display, an organic light-emitting diode (OLED) display, or the like.

The touch display screen 102 in embodiments of the present disclosure may include a touch screen and a display screen. The touch screen and the display screen are stacked, and the display screen is disposed on a bottom surface of the touch screen.

The AP 101 is configured to obtain repaired fingerprint data by denoising the fingerprint data according to pre-collected noise data, where the pre-collected noise data is collected in advance by the optical fingerprint recognition module 103 when there is no touch operation in the first area.

The pre-collected noise data may be collected in advance by the optical fingerprint recognition module 103 before the fingerprint data of the user is collected. The optical fingerprint recognition module 103 collects noise data in advance for processing when there is no touch operation in the first area. If the first area is covered with residual foreign material (e.g., a fingerprint mark), the result of the fingerprint data collected by the optical fingerprint recognition module 103 may be affected. By adopting embodiments of the present disclosure, before comparison of fingerprint data, the fingerprint data collected is denoised and repaired to obtain the repaired fingerprint data closer to a real fingerprint.

The AP 101 is further configured to determine whether the repaired fingerprint data is matched with pre-stored fingerprint template data.

The AP 101 is further configured to determine that fingerprint verification passes when the repaired fingerprint data is matched with the pre-stored fingerprint template data.

According to embodiments of the present disclosure, before comparison of fingerprint data, the AP 101 denoises and repairs the fingerprint data collected to obtain the repaired fingerprint data closer to a real fingerprint. By adopting embodiments of the present disclosure, the influence of the residual foreign material in the first area (fingerprint recognition area) of the touch display screen on the fingerprint data collected can be reduced, thereby facilitating the success of fingerprint matching.

In one embodiment, the noise data includes N noise-data points, the fingerprint data includes N fingerprint-data points, and the N noise-data points are in one-to-one correspondence with the N fingerprint-data points. The AP 101 configured to obtain the repaired fingerprint data by denoising the fingerprint data according to the pre-collected noise data is configured to: obtain a first data difference between a first noise-data point and a first fingerprint-data point; and obtain a first repaired fingerprint-data point by repairing the first fingerprint-data point according to the first data difference, where the repaired fingerprint data includes N repaired fingerprint-data points, the first noise-data point is any one of the N noise-data points, the first fingerprint-data point is one of the N fingerprint-data points which corresponds to the first noise-data point, and N is an integer greater than or equal to 2.

According to embodiments of the present disclosure, the optical fingerprint recognition module 103 can collect N fingerprint-data points of the user upon detecting the touch operation of the user in the first area, and can also collect N noise-data points when there is no touch operation in the first area. The N noise-data points are in one-to-one correspondence with the N fingerprint-data points. The AP 101 is configured to obtain a first data difference between a first noise-data point of the N noise-data points and a first fingerprint-data point (where the first noise-data point corresponds to the first fingerprint-data point), and obtain a first repaired fingerprint-data point by repairing the first fingerprint-data point according to the first data difference. In one embodiment, the AP 101 configured to obtain the first repaired fingerprint-data point by repairing the first fingerprint-data point according to the first data difference is configured to: use the first data difference between the first noise-data point and the first fingerprint-data point as a value of the first repaired fingerprint-data point. For example, a value of the first noise-data point collected by the optical fingerprint recognition module 103 is 50, and a value of the first fingerprint-data point is 150, that is, the difference between the two is 100, 100 can be used as the value of the first repaired fingerprint-data point.

In one embodiment, the AP 101 configured to obtain the first repaired fingerprint-data point by repairing the first fingerprint-data point according to the first data difference is configured to: determine whether the first data difference is greater than a preset threshold; use the first data difference as a value of the first repaired fingerprint-data point when the first data difference is greater than the preset threshold; or skip the repairing of the first fingerprint-data point when the first data difference is smaller than or equal to the preset threshold.

In general, when the optical fingerprint recognition module 103 collects fingerprint data at two times, there may be a slight difference between the fingerprint data points collected at the two times. That is, there may be a difference between fingerprint data collected by the optical fingerprint recognition module without finger press and fingerprint data collected by the optical fingerprint recognition module with finger press. Specifically, on one hand, if the fingerprint recognition area has no foreign material, the optical fingerprint recognition module can receive strong reflected lights when there is no touch operation in the first area, and correspondingly, a first data difference between a first fingerprint-data point collected at valleys of a fingerprint (concave portions of the fingerprint) and a corresponding first noise-data point is relatively small, while a first data difference between a first fingerprint-data point collected at ridges of the fingerprint (convex portions of the fingerprint) and a corresponding first noise-data point is relatively large. On the other hand, if the fingerprint recognition area has foreign material, the optical fingerprint recognition module can receive weak reflected lights when there is no touch operation in the first area, and correspondingly, a first data difference between a first fingerprint-data point collected at the valleys of the fingerprint and a corresponding first noise-data point is relatively large, while a first data difference between a first fingerprint-data point collected at the ridges of the fingerprint and a corresponding first noise-data point is relatively small. Thus, given the above, if the first data difference determined is relatively large, it indicates that a first data point is greatly affected by noise (e.g., foreign material) or the first data point is data collected at the convex portions of the fingerprint (i.e., the ridges of the fingerprint), and therefore, the first data point greatly affected by noise needs to be repaired and the first data difference is used as the value of the first repaired fingerprint-data point. If the first data difference is relatively small, it indicates that the first data point is less affected by noise or the first data point is data collected at the concave portions of the fingerprint (i.e., the valleys of the fingerprint), and therefore, the first data point does not need to be repaired. The preset threshold can be set in advance, for example, the preset threshold can be set to be 5. By implementing embodiments of the present disclosure, the complexity of repairing fingerprint data can be reduced, and so the speed of fingerprint comparison can be improved.

In one embodiment, the optical fingerprint recognition module 103 is further configured to periodically collect noise data when there is no touch operation in the first area.

The optical fingerprint recognition module 103 can periodically collect the noise data (in other words, collecting noise data every time interval), for example, a period is 1 minute, 5 minutes, and the like, which is not limited in embodiments of the present disclosure.

In one embodiment, the AP 101 is further configured to obtain the periodically collected noise data from the optical fingerprint recognition module 103, and take most-recently-collected noise data as the pre-collected noise data.

Each time after obtaining new noise data from the optical fingerprint recognition module 103, the AP 101 overwrites previously obtained noise data with the new noise data to ensure that the last collected noise data is used each time the fingerprint data is repaired, which improves the accuracy of fingerprint repair.

In one embodiment, the pre-collected noise data is any one of multiple noise data periodically collected by the optical fingerprint recognition module when there is no touch operation in the first area.

According to an embodiment of the disclosure, a method for optical fingerprint recognition is provided. The method is applicable to a terminal including an AP, a touch display screen, and an optical fingerprint recognition module having a fingerprint recognition area located in a first area of the touch display screen. The method includes the following. The optical fingerprint recognition module collects fingerprint data of a user when the touch display screen detects a touch operation of the user in the first area, and sends the fingerprint data to the AP. The AP obtains denoised fingerprint data by denoising the fingerprint data according to pre-collected noise data. The AP compares the denoised fingerprint data with pre-stored fingerprint template data, and determines that fingerprint verification passes upon determining that the denoised fingerprint data is matched with the pre-stored fingerprint template data.

In one embodiment, the pre-collected noise data includes N noise-data points, the fingerprint data includes N fingerprint-data points, the N noise-data points are in one-to-one correspondence with the N fingerprint-data points, the denoised fingerprint data includes N denoised fingerprint-data points, N is an integer greater than or equal to 2, and the AP obtains the denoised fingerprint data by denoising the fingerprint data according to the pre-collected noise data as follows. For each of the N noise-data points and each of the N fingerprint-data points, a data difference between the noise-data point and the fingerprint-data point is obtained, where the fingerprint-data point is one of the N fingerprint-data points which corresponds to the noise-data point. A denoised fingerprint-data point is obtained by denoising the fingerprint-data point according to the data difference.

In one embodiment, the denoised fingerprint-data point is obtained by denoising the fingerprint-data point according to the data difference as follows. Whether the data difference is greater than a preset threshold is determined. When the data difference is greater than the preset threshold, the data difference is used as a value of the denoised fingerprint-data point. When the data difference is smaller than or equal to the preset threshold, skip the denoising of the fingerprint-data point.

In one embodiment, prior to obtaining the data difference between the noise-data point and the fingerprint-data point, the method further includes the following. Whether the noise-data point satisfies a preset condition is determined. For example, the preset condition may be that the noise-data point is data collected when there is foreign material in the fingerprint recognition area. When the noise-data point satisfies the preset condition, proceed to the obtaining of the data difference.

In one embodiment, prior to collecting, with the optical fingerprint recognition module, the fingerprint data of the user, the method further includes the following. The optical fingerprint recognition module periodically collects noise data when there is no touch operation in the first area.

In one embodiment, after collecting periodically, with the optical fingerprint recognition module, the noise data when there is no touch operation in the first area, the method further includes the following. The AP obtains the noise data periodically collected from the optical fingerprint recognition module. The AP takes most-recently-collected noise data as the pre-collected noise data.

In one embodiment, the pre-collected noise data is any one of multiple noise data periodically collected by the optical fingerprint recognition module when there is no touch operation in the first area.

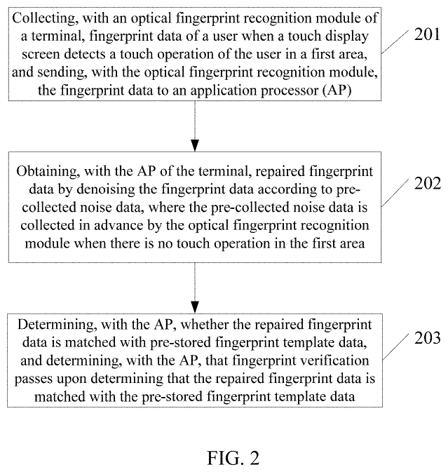

FIG. 2 is a schematic flowchart illustrating a method for optical fingerprint recognition according to an embodiment of the present disclosure. The method is applicable to a terminal including an AP, a touch display screen, and an optical fingerprint recognition module. The optical fingerprint recognition module has a fingerprint recognition area corresponding to a first area of the touch display screen. As illustrated in FIG. 2, the method may begin at block 201.

At block 201, when the touch display screen detects a touch operation of a user in the first area, the mobile terminal collects, with the optical fingerprint recognition module, fingerprint data of the user, and sends, with the optical fingerprint recognition module, the fingerprint data to the AP.

At block 202, the mobile terminal obtains, with the AP, repaired fingerprint data by denoising the fingerprint data according to pre-collected noise data, where the pre-collected noise data is collected in advance by the optical fingerprint recognition module when there is no touch operation in the first area.

At block 203, the mobile terminal determines, with the AP, whether the repaired fingerprint data matches with pre-stored fingerprint template data; when the repaired fingerprint data matches with the pre-stored fingerprint template data, fingerprint verification is successful; when the repaired fingerprint data fails to match with the pre-stored fingerprint template data, the fingerprint verification fails. Fingerprint verification may be applicable to scenarios such as fingerprint unlocking and fingerprint payment.

According to embodiments of the present disclosure, before comparison of fingerprint data, the AP denoises and repairs the fingerprint data collected to obtain the repaired fingerprint data closer to a real fingerprint. By adopting the embodiments of the present disclosure, the influence of the residual foreign material in the first area (fingerprint recognition area) of the touch display screen on the fingerprint data collected can be reduced, thereby facilitating the success of fingerprint matching.

In one embodiment, the noise data includes N noise-data points, the fingerprint data includes N fingerprint-data points, the N noise-data points are in one-to-one correspondence with the N fingerprint-data points, and the mobile terminal obtains, with the AP, the repaired fingerprint data by denoising the fingerprint data according to the pre-collected noise data as follows. The mobile terminal obtains, with the AP, a first data difference between a first noise-data point and a first fingerprint-data point. The mobile terminal obtains, with the AP, a first repaired fingerprint-data point by repairing the first fingerprint-data point according to the first data difference, where the repaired fingerprint data includes N repaired fingerprint-data points, the first noise-data point is any one of the N noise-data points, the first fingerprint-data point is one of the N fingerprint-data points which corresponds to the first noise-data point, and N is an integer greater than or equal to 2.

In one embodiment, the mobile terminal obtains, with the AP, the first repaired fingerprint-data point by repairing the first fingerprint-data point according to the first data difference as follows. The mobile terminal determines, with the AP, whether the first data difference is greater than a preset threshold. Upon determining that the first data difference is greater than the preset threshold, the mobile terminal uses, with the AP, the first data difference as a value of the first repaired fingerprint-data point. Upon determining that the first data difference is smaller than or equal to the preset threshold, the mobile terminal skips, with the AP, the repairing of the first fingerprint-data point.

By adopting embodiments of the present disclosure, the complexity of repairing fingerprint data can be reduced, and so the speed of fingerprint comparison can be improved.

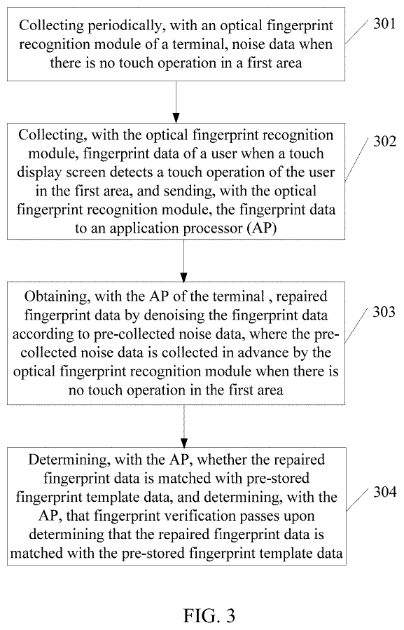

FIG. 3 is a schematic flowchart illustrating a method for optical fingerprint recognition according to another embodiment of the present disclosure. The method is applicable to a terminal including an AP, a touch display screen, and an optical fingerprint recognition module. The projection of a fingerprint recognition area of the optical fingerprint recognition module falls on a first area of the touch display screen. As illustrated in FIG. 3, the method may begin at block 301.

At block 301, the mobile terminal collects, with the optical fingerprint recognition module, noise data periodically when there is no touch operation in the first area.

At block 302, when the touch display screen detects a touch operation of a user in the first area, the mobile terminal collects, with the optical fingerprint recognition module, fingerprint data of the user and sends, with the optical fingerprint recognition module, the fingerprint data to the AP.

At block 303, the mobile terminal obtains, with the AP, repaired fingerprint data by denoising the fingerprint data according to pre-collected noise data, where the pre-collected noise data is collected in advance by the optical fingerprint recognition module when there is no touch operation in the first area.

In one embodiment, the pre-collected noise data is any one of multiple noise data periodically collected by the optical fingerprint recognition module when there is no touch operation in the first area.

At block 304, the mobile terminal determines, with the AP, whether the repaired fingerprint data is matched with pre-stored fingerprint template data; if the repaired fingerprint data is matched with the pre-stored fingerprint template data, fingerprint verification passes.

For details of the operations from 302 to 304, reference can be made to the operations from 201 to 203 described in conjunction with in FIG. 2, and it will not be repeated here.

According to embodiments of the present disclosure, before comparison of fingerprint data, the noise data is periodically collected in advance. After the fingerprint data is collected, the AP denoises the fingerprint data collected according to the pre-collected noise data, repairs the fingerprint data collected, and obtains the repaired fingerprint data closer to a real fingerprint. By adopting the embodiments of the present disclosure, the influence of the residual foreign material in the first area (fingerprint recognition area) of the touch display screen on the fingerprint data collected can be reduced, thereby improving success rate of fingerprint matching.

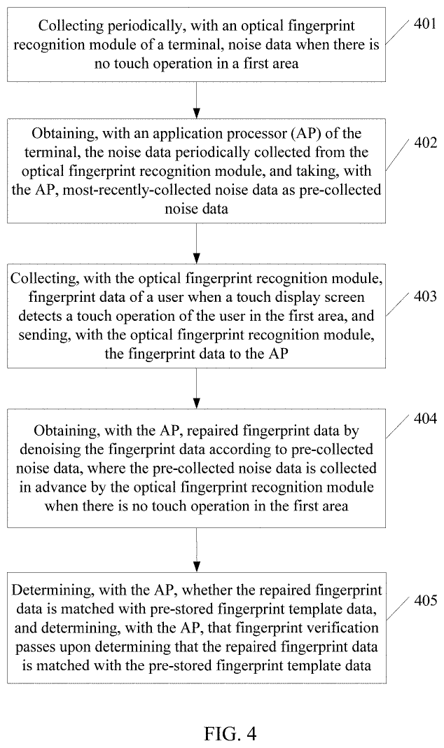

FIG. 4 is a schematic flowchart illustrating a method for optical fingerprint recognition according to another embodiment of the present disclosure. The method is applicable to a terminal including an AP, a touch display screen, and an optical fingerprint recognition module. The optical fingerprint recognition module has a fingerprint recognition area located in a first area of the touch display screen. As illustrated in FIG. 4, the method may begin at block 401.

At block 401, the mobile terminal collects, with the optical fingerprint recognition module, noise data periodically when there is no touch operation in the first area.

At block 402, the mobile terminal obtains, with the AP, the periodically collected noise data from the optical fingerprint recognition module, and takes, with the AP, most-recently-collected noise data as pre-collected noise data.

Each time after obtaining new noise data from the optical fingerprint recognition module 103, the AP overwrites previously obtained noise data with the new noise data to ensure that the fingerprint data is repaired using the last collected noise data every time, thereby improving the accuracy of fingerprint repair.

At block 403, when the touch display screen detects a touch operation of a user in the first area, the mobile terminal collects, with the optical fingerprint recognition module, fingerprint data of the user, and sends, with the optical fingerprint recognition module, the fingerprint data to the AP.

At block 404, the mobile terminal obtains, with the AP, repaired fingerprint data by denoising the fingerprint data according to the pre-collected noise data, where the pre-collected noise data is collected in advance by the optical fingerprint recognition module when there is no touch operation in the first area.

At block 405, the mobile terminal determines, with the AP, whether the repaired fingerprint data is matched with pre-stored fingerprint template data, and determines, with the AP, that fingerprint verification passes upon determining that the repaired fingerprint data is matched with the pre-stored fingerprint template data.

For details of the operations from 402 to 405, reference can be made to the operations from 301 to 304 described in conjunction with in FIG. 3, and it will not be repeated here.

According to embodiments of the present disclosure, before comparison of fingerprint data, the noise data is periodically collected in advance. After the fingerprint data is collected, the AP denoises the fingerprint data collected according to the latest collected noise data, repairs the fingerprint data collected, and obtains the repaired fingerprint data closer to a real fingerprint. By adopting the embodiments of the present disclosure, the influence of the residual foreign material in the first area (fingerprint recognition area) of the touch display screen on the fingerprint data collected can be reduced, thereby improving success rate of fingerprint matching.

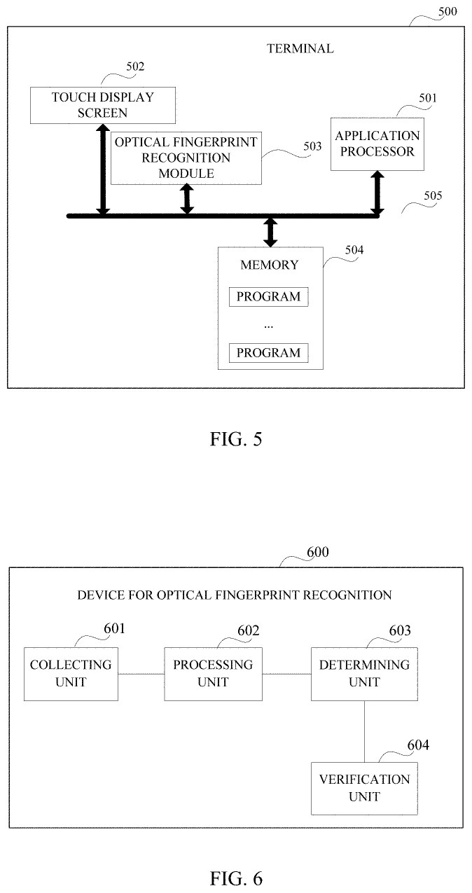

FIG. 5 is a schematic structural diagram illustrating a terminal according to another embodiment of the present disclosure. As illustrated in FIG. 5, a terminal 500 includes an AP 501, a touch display screen 502, an optical fingerprint recognition module 503, a memory 504, and one or more programs. The optical fingerprint recognition module has a fingerprint recognition area located in a first area of the touch display screen. The AP 501 is coupled with the touch display screen 502, the optical fingerprint recognition module 503, and the memory 504 via a data bus 505.

One or more programs are stored in the memory 504 and configured to be executed by the AP 501, the one or more programs include instructions configured to: collect fingerprint data of a user when the touch display screen 502 detects a touch operation of the user in the first area and send the fingerprint data to the AP 501; obtain repaired fingerprint data by denoising the fingerprint data according to pre-collected noise data, where the pre-collected noise data is collected in advance by the optical fingerprint recognition module 503 when there is no touch operation in the first area; and determine whether the repaired fingerprint data is matched with pre-stored fingerprint template data, and determine that fingerprint verification passes when the repaired fingerprint data is matched with the pre-stored fingerprint template data.

In one embodiment, the noise data includes N noise-data points, the fingerprint data includes N fingerprint-data points, the N noise-data points are in one-to-one correspondence with the N fingerprint-data points, and the instructions of the one or more programs configured to obtain the repaired fingerprint data by denoising the fingerprint data according to the pre-collected noise data are configured to: obtain a first data difference between a first noise-data point and a first fingerprint-data point; and obtain a first repaired fingerprint-data point by repairing the first fingerprint-data point according to the first data difference, where the repaired fingerprint data includes N repaired fingerprint-data points, the first noise-data point is any one of the N noise-data points, the first fingerprint-data point is one of the N fingerprint-data points which corresponds to the first noise-data point, and N is an integer greater than or equal to 2.

In one embodiment, the instructions of the one or more programs configured to obtain the first repaired fingerprint-data point by repairing the first fingerprint-data point according to the first data difference are configured to: determine whether the first data difference is greater than a preset threshold; use the first data difference as a value of the first repaired fingerprint-data point, when the first data difference is greater than the preset threshold; or skip the repairing of the first fingerprint-data point, when the first data difference is smaller than or equal to the preset threshold.

In one embodiment, the one or more programs further include instructions configured to: collect periodically noise data when there is no touch operation in the first area.

In one embodiment, the one or more programs further include instructions configured to: take most-recently-collected noise data as the pre-collected noise data, after collecting periodically the noise data when there is no touch operation in the first area.

In one embodiment, the pre-collected noise data is any one of multiple noise data periodically collected by the optical fingerprint recognition module 503 when there is no touch operation in the first area.

According to embodiments of the present disclosure, before comparison of fingerprint data, the AP denoises and repairs the fingerprint data collected to obtain the repaired fingerprint data closer to a real fingerprint. By adopting the embodiments of the present disclosure, the influence of the residual foreign material in the first area (fingerprint recognition area) of the touch display screen on the fingerprint data collected can be reduced, thereby facilitating the success of fingerprint matching.

FIG. 6 is a schematic structural diagram illustrating a device for optical fingerprint recognition according to an embodiment of the present disclosure. A device 600 for optical fingerprint recognition is applicable to a terminal including an AP, a touch display screen, and an optical fingerprint recognition module. The optical fingerprint recognition module has a fingerprint recognition area located in a first area of the touch display screen. As illustrated in FIG. 6, the device 600 includes a collecting unit 601, a processing unit 602, a determining unit 603, and a verification unit 604.

The collecting unit 601 is configured to control the optical fingerprint recognition module to collect fingerprint data of a user when the touch display screen detects a touch operation of the user in the first area and send the fingerprint data to the AP.

The processing unit 602 is configured to obtain, with the AP, repaired fingerprint data by denoising the fingerprint data according to pre-collected noise data, where the pre-collected noise data is collected in advance by the optical fingerprint recognition module when there is no touch operation in the first area.

The determining unit 603 is configured to determine, with the AP, whether the repaired fingerprint data is matched with pre-stored fingerprint template data.

The verification unit 604 is configured to determine that fingerprint verification passes when the determining unit 603 determines that the repaired fingerprint data is matched with the pre-stored fingerprint template data.

According to embodiments of the present disclosure, before comparison of fingerprint data, the processing unit 602 is configured to denoise and repair the fingerprint data collected to obtain the repaired fingerprint data closer to a real fingerprint. By adopting the embodiments of the present disclosure, the influence of the residual foreign material in the first area (fingerprint recognition area) of the touch display screen on the fingerprint data collected can be reduced, thereby facilitating the success of fingerprint matching.

In one embodiment, the noise data includes N noise-data points, the fingerprint data includes N fingerprint-data points, the N noise-data points are in one-to-one correspondence with the N fingerprint-data points, and the processing unit 602 configured to obtain, with the AP, the repaired fingerprint data by denoising the fingerprint data according to the pre-collected noise data is configured to: obtain a first data difference between a first noise-data point and a first fingerprint-data point; and obtain a first repaired fingerprint-data point by repairing the first fingerprint-data point according to the first data difference, where the repaired fingerprint data includes N repaired fingerprint-data points, the first noise-data point is any one of the N noise-data points, the first fingerprint-data point is one of the N fingerprint-data points which corresponds to the first noise-data point, and N is an integer greater than or equal to 2.

In one embodiment, the processing unit 602 configured to obtain, with the AP, the first repaired fingerprint-data point by repairing the first fingerprint-data point according to the first data difference is configured to: determine whether the first data difference is greater than a preset threshold; use the first data difference as a value of the first repaired fingerprint-data point, when the first data difference is greater than the preset threshold; or skip the repairing of the first fingerprint-data point, when the first data difference is smaller than or equal to the preset threshold.

In one embodiment, the collecting unit 601 is further configured to periodically collect, with the optical fingerprint recognition module, noise data when there is no touch operation in the first area.

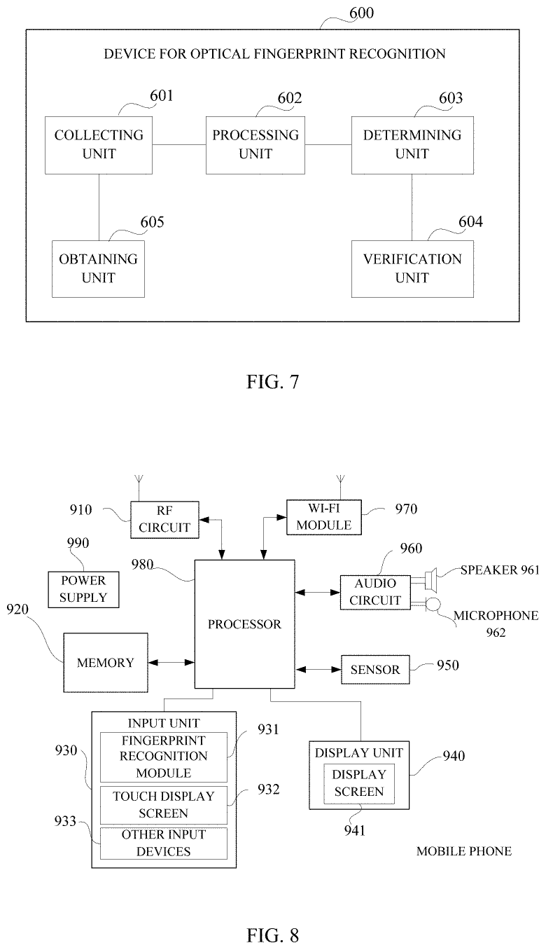

In one embodiment, as illustrated in FIG. 7, the device 600 for optical fingerprint recognition further includes an obtaining unit 605. The obtaining unit 605 is configured to: obtain, with the AP, the periodically collected noise data from the optical fingerprint recognition module; and take, with the AP, most-recently-collected noise data as the pre-collected noise data.

In one embodiment, the pre-collected noise data is any one of multiple noise data periodically collected by the optical fingerprint recognition module when there is no touch operation in the first area.

According to embodiments of the present disclosure, before comparison of fingerprint data, the noise data can be periodically collected in advance. After the fingerprint data is collected, the fingerprint data collected is denoised according to the latest collected noise data, and fingerprint data collected is repaired, so as to obtain the repaired fingerprint data closer to a real fingerprint. By adopting the embodiments of the present disclosure, the influence of the residual foreign material in the first area (fingerprint recognition area) of the touch display screen on the collected fingerprint data can be reduced, and so success rate of fingerprint matching can be improved.

Embodiments of the present disclosure further provide another terminal. As illustrated in FIG. 8, only parts related to the embodiments of the present disclosure are illustrated for ease of description. For technical details not described, reference may be made to the method embodiments of the present disclosure. The terminal may be any terminal device, such as a mobile phone, a tablet computer, a personal digital assistant (PDA), a point of sale terminal (POS), an on-board computer and the like. The following describes a mobile phone as an example of the terminal.

FIG. 8 is a block diagram of a part of a structure of a mobile phone related to a terminal according to an embodiment of the present disclosure. As illustrated in FIG. 8, the mobile phone includes a radio frequency (RF) circuit 910, a memory 920, an input unit 930, a display unit 940, a sensor 950, an audio circuit 960, a wireless fidelity (Wi-Fi) module 970, a processor 980, a power supply 990, and other components. Those skilled in the art can understand that the structure of the mobile phone illustrated in FIG. 8 does not constitute any limitation on a mobile phone. The mobile phone configured to implement technical solutions of the present disclosure may include more or fewer components than illustrated, or may combine certain components, or may adopt different arrangements of components.

In the following, various components of the mobile phone will be described in detail with reference to FIG. 8.

The RF circuit 910 is configured to transmit or receive information. Generally, the RF circuit 910 includes but is not limited to an antenna, at least one amplifier, a transceiver, a coupler, a low noise amplifier (LNA), a duplexer, and the like. In addition, the RF circuit 910 may also communicate with the network and other devices via wireless communication. The above wireless communication may use any communication standard or protocol, which includes but is not limited to global system of mobile communication (GSM), general packet radio service (GPRS), code division multiple access (CDMA), wideband code division multiple access (WCDMA), long term evolution (LTE), E-mail, short messaging service (SMS), and so on.

The memory 920 is configured to store software programs and modules, and the processor 980 is configured to execute various function applications and data processing of the mobile phone by running the software programs and the modules stored in the memory 920. The memory 920 mainly includes a program storing region and a data storing region. The program storing region may store an operating system, application programs required for at least one function and so on. The data storing region may store data created according to use of the mobile phone, and so on. In addition, the memory 920 may include a high-speed random access memory (RAM), and may further include a non-transitory memory such as at least one disk storage device, a flash device, or other non-transitory solid storage devices.

The input unit 930 is configured to receive input digital or character information and generate key signal input associated with user setting and function control of the mobile phone. In one implementation, the input unit 930 may include a fingerprint recognition module 931 (e.g., an optical fingerprint recognition module), a touch display screen 932, and other input devices 933. The fingerprint recognition module 931 can collect fingerprint data of the user. In addition to the fingerprint recognition module 931, the input unit 930 may further include other input devices 933. In one implementation, other input devices 933 may include, but not limit to, one or more of a touch screen, a physical key, a function key (such as a volume control key, a switch key, etc.), a trackball, a mouse, a joystick, and the like.

The display unit 940 is configured to display information input by the user or information provided for the user or various menus of the mobile phone. The display unit 940 may include a display screen 941. In at least one implementation, the display screen 941 may be in the form of a liquid crystal display (LCD), an organic light-emitting diode (OLED), and so on. Although the fingerprint recognition module 931 and the display screen 941 are illustrated as two separate components in FIG. 8 to realize the input and output functions of the mobile phone, in some embodiments, the fingerprint recognition module 931 may be integrated with the display screen 941 to implement the input and output functions of the mobile phone.

The mobile phone may further include at least one sensor 950, such as, a light sensor, a motion sensor, and other sensors. In one implementation, the light sensor may include an ambient light sensor and a proximity sensor, the ambient light sensor may adjust the brightness of the display screen 941 according to ambient lights, and the proximity sensor may turn off the display screen 941 and/or backlight when the mobile phone reaches nearby the ear. As a kind of motion sensor, an accelerometer sensor can detect the magnitude of acceleration in all directions (typically three axes) and when the mobile phone is stationary, the accelerometer sensor can detect the magnitude and direction of gravity; the accelerometer sensor can also identify mobile-phone gestures related applications (such as vertical and horizontal screen switch, related games, magnetometer attitude calibration), or the accelerometer sensor can be used for vibration-recognition related functions (such as a pedometer, percussion) and so on. The mobile phone can also be equipped with a gyroscope, a barometer, a hygrometer, a thermometer, and an infrared sensor and other sensors, and it will not be repeated herein.

The audio circuit 960, a speaker 961, and a microphone 962 may provide an audio interface between the user and the mobile phone. The audio circuit 960 may convert the received audio data into electrical signals and transfer the electrical signals to the speaker 961; thereafter the speaker 961 converts the electrical signals into sound signals to output. On the other hand, the microphone 962 converts received sound signals into electrical signals, which will be received and converted into audio data by the audio circuit 960 to output. The audio data is then processed and transmitted by the processor 980 via the RF circuit 910 to another mobile phone for example, or, the audio data is output to the memory 920 for further processing.

Wi-Fi belongs to a short-range wireless transmission technology. With aid of the Wi-Fi module 970, the mobile phone may assist the user in E-mail receiving and sending, webpage browsing, access to streaming media and the like. Wi-Fi provides users with wireless broadband Internet access. Although the Wi-Fi module 970 is illustrated in FIG. 8, it should be understood that the Wi-Fi module 970 is not essential to the mobile phone and can be omitted according to actual needs without departing from the essential nature of the present disclosure.

The processor 980 is a control center of the mobile phone. It uses various interfaces and lines to connect various parts of the whole mobile phone, runs or executes software programs and/or modules stored in the memory 920, and calls data stored in the memory 920 to perform various functions of the mobile phone and process data, thereby monitoring the mobile phone. In at least one implementation, the processor 980 may include one or more processing units; for example, the processor 980 may integrate an application processor and a modem processor, where the application processor mainly handles the operating system, the user interface, the application programs, and so on, and the modem processor mainly processes wireless communication. It will be appreciated that the above-mentioned modem processor may not be integrated into the processor 980.

The mobile phone also includes the power supply 990 (e.g., a battery) that supplies power to various components. For instance, the power supply 990 may be logically connected to the processor 980 via a power management system to enable management of charging, discharging, and power consumption through the power management system.

Although not illustrated, the mobile phone may include a camera, a Bluetooth module, etc., and the present disclosure will not elaborate herein.

Embodiments of the present disclosure further provide a non-transitory computer readable storage medium. The non-transitory computer readable storage medium is configured to store computer programs which, when executed by a processor of a terminal, cause the processor to carry out following actions. Fingerprint data of a user is collected when a touch operation of the user is detected and the fingerprint data is sent to an AP of the terminal. Denoised fingerprint data is obtained by denoising the fingerprint data according to pre-collected noise data. The denoised fingerprint data is compared with pre-stored fingerprint template data. Upon determining that the denoised fingerprint data is matched with the pre-stored fingerprint template data, determine that fingerprint verification passes.

In one embodiment, the pre-collected noise data includes N noise-data points, the fingerprint data includes N fingerprint-data points, the N noise-data points are in one-to-one correspondence with the N fingerprint-data points, the denoised fingerprint data includes N denoised fingerprint-data points, N is an integer greater than or equal to 2. In terms of obtaining the denoised fingerprint data by denoising the fingerprint data according to the pre-collected noise data, the computer programs are executed by the processor to carry out following actions. For each of the N noise-data points and each of the N fingerprint-data points, a data difference between the noise-data point and the fingerprint-data point is obtained, where the fingerprint-data point is one of the N fingerprint-data points which corresponds to the noise-data point; a denoised fingerprint-data point is obtained by denoising the fingerprint-data point according to the data difference.

In one embodiment, in terms of obtaining the denoised fingerprint-data point by denoising the fingerprint-data point according to the data difference, the computer programs are executed by the processor to carry out following actions. Whether the data difference is greater than a preset threshold is determined. When the data difference is greater than the preset threshold, the data difference is used as a value of the denoised fingerprint-data point. When the data difference is smaller than or equal to the preset threshold, skip the denoising of the fingerprint-data point.

In one embodiment, the computer programs are further executed by the processor to carry out following actions. Whether the noise-data point satisfies a preset condition is determined. When the noise-data point satisfies the preset condition, proceed to the obtaining of the data difference.

In one embodiment, the computer programs are further executed by the processor to carry out following actions. Noise data is periodically collected when there is no touch operation in the first area.

In one embodiment, the computer programs are further executed by the processor to carry out following actions. The noise data periodically collected is obtained from the optical fingerprint recognition module. Most-recently-collected noise data is taken as the pre-collected noise data.

In one embodiment, the pre-collected noise data is any one of multiple noise data periodically collected by the optical fingerprint recognition module when there is no touch operation in the first area.

It should be understood that the implementation process will not be detailed herein and reference may be made to the foregoing method embodiments.

Embodiments of the present disclosure further provide a computer program product. The computer program product includes a non-transitory computer readable storage medium which is configured to store computer programs, the computer programs are operable with a computer to execute part or all of the operations described in any of the method for optical fingerprint recognition described in the foregoing method embodiments.

It is to be noted that, for the sake of simplicity, the foregoing method embodiments are described as a series of action combinations, however, it will be appreciated by those skilled in the art that the present disclosure is not limited by the sequence of actions described. That is because that, according to the present disclosure, certain steps or operations may be performed in other order or simultaneously. Besides, it will be appreciated by those skilled in the art that the embodiments described in the specification are exemplary embodiments and the actions and modules involved are not necessarily essential to the present disclosure.

In the foregoing embodiments, the description of each embodiment has its own emphasis. For the parts not described in detail in one embodiment, reference may be made to related descriptions in other embodiments.

In the embodiments of the present disclosure, it should be understood that, the apparatus disclosed in embodiments provided herein may be implemented in other manners. For example, the device/apparatus embodiments described above are merely illustrative; for instance, the division of the unit is only a logical function division and there can be other manners of division during actual implementations, for example, multiple units or assemblies may be combined or may be integrated into another system, or some features may be ignored, omitted, or not performed. In addition, coupling or communication connection between each illustrated or discussed component may be direct coupling or communication connection, or may be indirect coupling or communication among devices or units via some interfaces, and may be electrical connection or other forms of connection.

1. A method for optical fingerprint recognition, applicable to a terminal comprising an application processor (AP), a touch display screen, and an optical fingerprint recognition module having a fingerprint recognition area located in a first area of the touch display screen, the method comprising:
collecting, with the optical fingerprint recognition module, fingerprint data of a user when the touch display screen detects a touch operation of the user in the first area, and sending, with the optical fingerprint recognition module, the fingerprint data to the AP;
obtaining, with the AP, denoised fingerprint data by denoising the fingerprint data according to pre-collected noise data;
comparing, with the AP, the denoised fingerprint data with pre-stored fingerprint template data; and
determining, with the AP, that fingerprint verification passes upon determining that the denoised fingerprint data is matched with the pre-stored fingerprint template data.

2. The method of claim 1, wherein the pre-collected noise data comprises N noise-data points, the fingerprint data comprises N fingerprint-data points, the N noise-data points are in one-to-one correspondence with the N fingerprint-data points, the denoised fingerprint data comprises N denoised fingerprint-data points, N is an integer greater than or equal to 2, and obtaining, with the AP, the denoised fingerprint data by denoising the fingerprint data according to the pre-collected noise data comprises:
for each of the N noise-data points and each of the N fingerprint-data points:
obtaining a data difference between the noise-data point and the fingerprint-data point, wherein the fingerprint-data point is one of the N fingerprint-data points which corresponds to the noise-data point; and
obtaining a denoised fingerprint-data point by denoising the fingerprint-data point according to the data difference.

3. The method of claim 2, wherein obtaining the denoised fingerprint-data point by denoising the fingerprint-data point according to the data difference comprises:
determining whether the data difference is greater than a preset threshold;
using the data difference as a value of the denoised fingerprint-data point, upon determining that the data difference is greater than the preset threshold; or
skipping the denoising of the fingerprint-data point, upon determining that the data difference is smaller than or equal to the preset threshold.

4. The method of claim 2, further comprising the following prior to obtaining the data difference between the noise-data point and the fingerprint-data point:
determining whether the noise-data point satisfies a preset condition; and
proceeding to the obtaining of the data difference upon determining that the noise-data point satisfies the preset condition.

5. The method of claim 1, further comprising the following prior to collecting, with the optical fingerprint recognition module, the fingerprint data of the user:
collecting periodically, with the optical fingerprint recognition module, noise data when there is no touch operation in the first area.

6. The method of claim 5, further comprising the following after collecting periodically, with the optical fingerprint recognition module, the noise data when there is no touch operation in the first area:
obtaining, with the AP, the noise data periodically collected from the optical fingerprint recognition module; and
taking, with the AP, most-recently-collected noise data as the pre-collected noise data.

7. The method of claim 5, wherein the pre-collected noise data is any one of multiple noise data periodically collected by the optical fingerprint recognition module when there is no touch operation in the first area.

8. A terminal, comprising an application processor (AP), a touch display screen, and an optical fingerprint recognition module having a fingerprint recognition area located in a first area of the touch display screen;
the optical fingerprint recognition module being configured to collect fingerprint data of a user when the touch display screen detects a touch operation of the user in the first area and send the fingerprint data to the AP;
the AP being configured to obtain denoised fingerprint data by denoising the fingerprint data according to pre-collected noise data;
the AP being further configured to compare the denoised fingerprint data with pre-stored fingerprint template data; and
the AP being further configured to determine that fingerprint verification passes when the denoised fingerprint data is matched with the pre-stored fingerprint template data.

9. The terminal of claim 8, wherein the pre-collected noise data comprises N noise-data points, the fingerprint data comprises N fingerprint-data points, the N noise-data points are in one-to-one correspondence with the N fingerprint-data points, the denoised fingerprint data comprises N denoised fingerprint-data points, N is an integer greater than or equal to 2, and the AP configured to obtain the denoised fingerprint data by denoising the fingerprint data according to the pre-collected noise data is configured to:
for each of the N noise-data points and each of the N fingerprint-data points:
obtain a data difference between the noise-data point and the fingerprint-data point, wherein the fingerprint-data point is one of the N fingerprint-data points which corresponds to the noise-data point; and
obtain a denoised fingerprint-data point by denoising the fingerprint-data point according to the data difference.

10. The terminal of claim 9, wherein the AP configured to obtain the denoised fingerprint-data point by denoising the fingerprint-data point according to the data difference is configured to:
determine whether the data difference is greater than a preset threshold;
use the data difference as a value of the denoised fingerprint-data point, upon determining that the data difference is greater than the preset threshold; or
skip the denoising of the fingerprint-data point, upon determining that the data difference is smaller than or equal to the preset threshold.

11. The terminal of claim 9, wherein the AP is further configured to:
determine whether the noise-data point satisfies a preset condition; and
obtain the data difference, upon determining that the noise-data point satisfies the preset condition.

12. The terminal of claim 8, wherein the optical fingerprint recognition module is further configured to periodically collect noise data when there is no touch operation in the first area.

13. The terminal of claim 12, wherein the AP is further configured to:
obtain the noise data periodically collected from the optical fingerprint recognition module; and
take most-recently-collected noise data as the pre-collected noise data.

14. The terminal of claim 12, wherein the pre-collected noise data is any one of multiple noise data periodically collected by the optical fingerprint recognition module when there is no touch operation in the first area.

15. A non-transitory computer readable storage medium, configured to store computer programs which, when executed by a processor of a terminal, cause the processor to carry out actions, comprising:
collecting fingerprint data of a user when a touch operation of the user is detected, and sending the fingerprint data to an application processor (AP) of the terminal;
obtaining denoised fingerprint data by denoising the fingerprint data according to pre-collected noise data;
comparing the denoised fingerprint data with pre-stored fingerprint template data; and
determining that fingerprint verification passes upon determining that the denoised fingerprint data is matched with the pre-stored fingerprint template data.

16. The non-transitory computer readable storage medium of claim 15, wherein the pre-collected noise data comprises N noise-data points, the fingerprint data comprises N fingerprint-data points, the N noise-data points are in one-to-one correspondence with the N fingerprint-data points, the denoised fingerprint data comprises N denoised fingerprint-data points, N is an integer greater than or equal to 2, and wherein:
the computer programs executed by the processor to carry out the action of obtaining the denoised fingerprint data by denoising the fingerprint data according to the pre-collected noise data are executed by the processor to carry out actions, comprising:
for each of the N noise-data points and each of the N fingerprint-data points:
obtaining a data difference between the noise-data point and the fingerprint-data point, wherein the fingerprint-data point is one of the N fingerprint-data points which corresponds to the noise-data point; and
obtaining a denoised fingerprint-data point by denoising the fingerprint-data point according to the data difference.

17. The non-transitory computer readable storage medium of claim 16, wherein the computer programs executed by the processor to carry out the action of obtaining the denoised fingerprint-data point by denoising the fingerprint-data point according to the data difference are executed by the processor to carry out actions, comprising:
determining whether the noise-data point satisfies a preset condition;
determining whether the data difference is greater than a preset threshold, upon determining that the noise-data point satisfies the preset condition;
using the data difference as a value of the denoised fingerprint-data point, upon determining that the data difference is greater than the preset threshold; or
skipping the denoising of the fingerprint-data point, upon determining that the data difference is smaller than or equal to the preset threshold.

18. The non-transitory computer readable storage medium of claim 15, wherein the computer programs are further executed by the processor to carry out actions, comprising:
collecting periodically noise data when there is no touch operation in the first area.

19. The non-transitory computer readable storage medium of claim 18, wherein the computer programs are further executed by the processor to carry out actions, comprising:
obtaining the noise data periodically collected from the optical fingerprint recognition module; and
taking most-recently-collected noise data as the pre-collected noise data.

20. The non-transitory computer readable storage medium of claim 18, wherein the pre-collected noise data is any one of multiple noise data periodically collected by the optical fingerprint recognition module when there is no touch operation in the first area.
